(19) United States
(12) Patent Application Publication
(10) Pub. No.: US 2005/0174330 A1
(43) Pub. Date: Aug. 11, 2005

(54) Computer input devices

(75) Inventor: Donald G. Varga, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands, Inc., Lincolnshire, IL (US)

(21) Appl. No.: 11/038,895

(22) Filed: Jan. 18, 2005

Related U.S. Application Data
(60) Provisional application No. 60/542,535, filed on Feb. 6, 2004.

(51) Int. Cl. G09G 5/08

(52) U.S. Cl. 345/163

(57) ABSTRACT

Computer input devices and methods of assembling computer input devices are disclosed. In one embodiment, a computer input device comprises a miniature input device and a cover structure. The cover structure includes a cavity for receiving the miniature input device and a gripping region for a hand. The miniature input device includes a button. The button is accessible through the cover structure.

### CROSS-REFERENCE TO RELATED APPLICATIONS

This patent application is a non-provisional of and claims the benefit of the filing date of U.S. Provisional Application No. 60/542,535, filed on Feb. 6, 2004, which is herein incorporated by reference in its entirety.

### BACKGROUND OF THE INVENTION

There are a variety of different types of input devices for a computer that may be used to control a cursor on a computer display screen. Such input devices may also be referred to as pointing devices. One of the more popular pointing devices is a mouse. A mouse tracks the movement of a user's hand as the user moves the mouse on a surface. As is well known in the art, the mouse may include components to track movement mechanically or optically. Another popular input device that may be used to control a cursor is a trackball. A trackball is a stationary pointing device that includes a moveable ball associated with one or more buttons. A user may move the ball with a finger or a thumb to move the cursor on the computer display screen.

Users are given the option to purchase a mouse in a standard size or a miniature size. A standard size mouse may be more comfortable for an adult to use, as the shape may conform better to the hand of an adult. However, the standard size mouse may be bulky when traveling and may be difficult to operate in a small space, such as the seat of an airplane. The miniature mouse, also referred to as a mini-mouse or pocket mouse, may be easier to operate in smaller spaces and may be more convenient to carry when traveling. Additionally, the miniature mouse may be better-suited for use by children than a standard size mouse. Given that both sizes have different advantages according to the circumstances, a user may need to purchase both size mice in order to meet varying needs.

A number of devices, such as stationary wrist-rests and moveable mouse supports, have been developed to provide additional comfort to a user while using a mouse. A stationary wrist-rest may be positioned on one side of a mouse pad to alleviate muscle fatigue. However, stationary wrist-rests may interfere with the movement of the user's hand and the movement of the mouse. Moveable-mouse supports may also not be fully satisfactory to a user. Some types of moveable mouse supports may not snugly fit to the mouse and thus users may struggle to keep the mouse in place within the support. Other types of moveable mouse supports may need to be fastened to the mouse with VELCRO™ or other type of fastener. A third type of support may pressure fit against a mouse or other input device and may thus eliminate some of the problems of other types of mouse supports. But, this type of moveable mouse support, as with the other devices, may need to be purchased separately, thus incurring additional costs to the user.

Embodiments of the invention address the above problems and other problems individually and collectively.

### BRIEF SUMMARY OF THE INVENTION

Computer input devices and methods of assembling computer input devices are disclosed. In one embodiment, a computer input device comprises a miniature input device and a cover structure. The cover structure includes a cavity for receiving the miniature input device and a gripping region for a hand. The miniature input device includes a button, which is accessible through the cover structure.

In another embodiment, a method which may be used to assemble a computer input device is disclosed. The method comprises obtaining a miniature input device having a button and obtaining a cover structure. The obtained cover structure includes a cavity for receiving the miniature input device and a gripping region for a hand. The method further comprises placing the cover structure on the miniature input device. The miniature input device is detachably coupled to the cover structure and the button is accessible through the cover structure.

In a third embodiment, a computer input device for controlling movement of a cursor on a computer display is disclosed. The computer input device comprises a cover structure and a button. The cover structure includes a gripping region and a palm region for a hand, the gripping region and the palm region including a soft material. The button is for actuation by a finger of the hand.

### BRIEF DESCRIPTION OF THE DRAWINGS

Illustrative embodiments in accordance with the invention are illustrated in the drawings in which:

FIG. 1 illustrates a top plan view of an exemplary computer input device according to one embodiment;

FIG. 2 illustrates an exemplary cross-sectional view of the computer input device of FIG. 1;

FIG. 3 illustrates an exemplary miniature input device that may be included in the computer input device of FIG. 1;

FIGS. 4A-4C show parts of the cover structure 14. FIG. 4A shows a top plan view of a bezeled structure comprising a rigid material. FIG. 4B shows a top plan view of a jacket. FIG. 4C shows a top plan view of a carrier.

FIG. 5 illustrates an exemplary bottom surface of a cover structure;

FIG. 6 illustrates an exemplary cover structure that may be included in the computer input device of FIG. 1;

FIG. 7 is a flow diagram illustrating an exemplary method of assembling a computer input device;

FIG. 8 illustrates an exemplary assembly of a computer input device;

FIG. 9 illustrates compressive pressures applied to a human hand by the use of a mouse; and

FIG. 10 illustrates a second exemplary embodiment of a computer input device.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details.

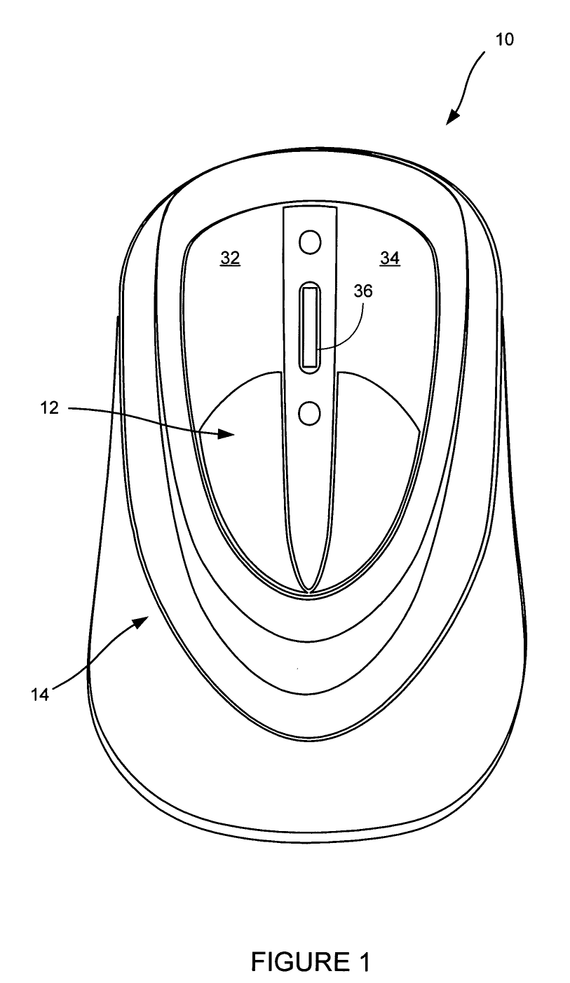

FIG. 1 illustrates an exemplary embodiment of a computer input device 10. The computer input device 10 includes a miniature input device 12 and a cover structure 14. The miniature input device 12 may be a smaller sized version of a standard size pointing device used to control the movement of a cursor on a computer display. By way of example, miniature input device 12 may be a mini-mouse (optical or mechanical) or a miniature size trackball device. Miniature input device 12 may be a fully functional standalone input device that may be used separately or in conjunction with cover structure 14.

In embodiments of the invention, the miniature input device 12 has one or more dimensions that are smaller than conventional input devices such as conventional computer mice for use with an ordinary adult hand. The size may be 90% (or less) of the size of a conventional computer input device. For example, in some embodiments, the miniature input device 12 has dimensions less than 5 inches (e.g., less than 4 inches) in length, 2 inches (e.g., less than 1.75 inches) in height, and/or 3 inches (e.g., less than 2 inches) in width.

As will be described in further detail below, miniature input device may be removably coupled with cover structure 14. Thus, cover structure 14 may be used to modify the dimensions of miniature input device 12 to a standard size computer input device 10. For example, in one embodiment, the miniature input device may have a length of approximately 2.5-4.0 inches (e.g., 3.5 inches) and a width of approximately 1.25-2.5 inches (e.g., 2 inches). When miniature input device is removably coupled with cover structure 14, a standard size computer input device may be formed having a length of approximately 4-6 inches (e.g., 5 inches) and a width of approximately 2.5-4 inches (e.g., 3 inches). Cover structure 14 includes a gripping region for a hand of the user to use the computer input device 10 and one or more buttons associated with miniature input device 12 may be accessible through cover structure 14. The gripping region may be on the sides of the cover structure.

As shown in FIG. 1, buttons 32, 34 and a scroll wheel 36 in the miniature input device are exposed through the cover structure 14 and are accessible to the hand of the user. The buttons 32, 34, and the scroll wheel 36 are described in further detail below.

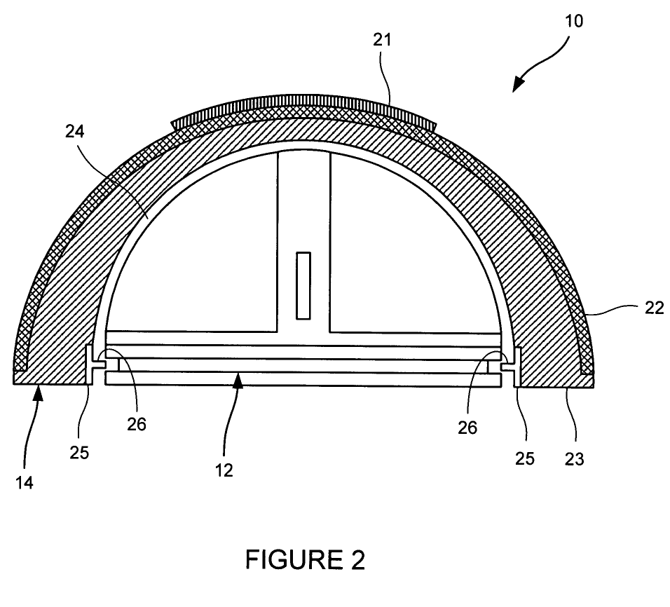

Referring to FIG. 2, an exemplary embodiment of cover structure 14 will be described in more detail. FIG. 2 illustrates an exemplary front cross-sectional view of computer input device 10. Cover structure 14 includes a cavity 24 for receiving miniature input device 12. Cavity 24 may have any suitable shape and may be cooperatively structured with the outer surfaces of the miniature input device 12. As one example, cavity 24 may be defined by a ring structure formed in cover structure 14.

In one embodiment, the cover structure 14 may comprise a rigid material 23. The inner surfaces of the cover structure 14 may comprise an engaging material 25, which has a high coefficient of friction, such as an elastomer (e.g. styrene-butadiene such as Kraton, neoprene, and urethane), thermoplastic rubber, or rubber. In this embodiment, miniature input device 12 may be removably coupled with cover structure 14 by applying force to cover 14 or miniature input device 12. Miniature input device 12 may thus be removably coupled to cover structure 14 by the applied force and the resulting frictional force which develops between miniature input device 12 and the engaging material 25. The engaging material 25 may also help prevent scratching on miniature input device 12 as it is attached and detached from cover structure 14.

In alternative embodiments, surfaces defining cavity 24 may comprise a different type of material than the rigid material 23. Additionally, miniature input device 12 may be removably coupled to cover structure by means other than the “friction fit” means described above. For example, miniature input device 12 may be removably coupled to cover structure 14 by a fastener (e.g., a loop and hook fastener such as VELCRO™), snaps, or other type of attachment member(s) or adhesives that allow miniature input device 12 to be removably coupled to cover structure 14.

The cover structure 14 may further include a plurality of projections 26 along a region near a bottom surface of cavity 24 formed by the cover structure 14. Projections 26 help hold miniature input device 12 in place within cavity 24. In one embodiment, projections 26 may be formed of an engaging material 25, such as an elastomer (e.g., styrene-butadiene, such as Kraton) which, may be co-molded, glued, or otherwise permanently attached to material rigid 23. Projections 26 may fit into recesses in the miniature input device 12 or may press against a flat side surface of the miniature input device 12. Engaging material 25 may be soft and may help reduce scratching of miniature input device 12 as it is attached and detached from cover structure 14. In some instances, the engaging material 25 may also extend along a bottom strip of cavity 24 near a bottom surface to further reduce the chances of scratching miniature input device 12. In alternative embodiments, projections 26 may be formed of a different material or the same material as the rigid material 23. Additionally, projections 25 may be located in different areas of the surface defining the cavity 24 than areas that have been described and illustrated.

Cover structure 14 may further include a soft (e.g., cushioning material) 22, such as gel or foam. Soft material 22 may be on one or more surfaces coming into contact with the hand of a user. For example, soft material 22 may be included in a palm region of cover structure 14 and/or a gripping region of cover structure 14. Thus, soft material 22 may make it more comfortable for a user to use computer input device 10.

In one embodiment, the soft material 22 may a self-skinning foam that forms a durable exterior layer, such as urethane. Alternatively, soft material 22 may be or comprise a gel or non self-skinning foam that may be covered with a protective covering or elastomeric material. In some cases, soft material 22 may not be co-molded to any other material. In a co-molding process, a soft material and a rigid material are molded together so that the soft material and the rigid material are permanently affixed to each other. Since embodiments of the invention do not require co-molding, embodiments of the invention advantageously allow for the selection of a material 22 with a lower durometer value (e.g., approximately 30 to 70 degrees shore OO), since most co-molded soft materials have high durometer values. Materials that have lower durometer values are softer and are more comfortable for a user. Additionally, as will be described in further detail below, soft material 22 may be removably coupled to the rigid material 23 to form the cover structure 14 so that the soft material 22 can be changed to suit the user's preferences. In alternative embodiments, soft material 22 may be a material, such as a polymer (e.g., Kraton®) co-molded with another material of cover structure 14, such as rigid material 23. Additionally, in some embodiments, the soft material 22 may be a gripping material and thus, in those embodiments, the cover structure 14 may not include projections 26.

Cover structure 12 further includes a second rigid material 21 along a portion of the top surface of material 22. Second rigid material 21 may comprise a rigid plastic or other rigid material which may be used to seal or form the top opening of cavity 24 and/or to hold soft material 22 in place and to provide a surface capable of accepting snaps or fasteners (e.g., screws). In alternative embodiments, soft material 22 may extend completely along the outer top surface of cover structure 14 and the second rigid material 21 may not be included. Soft material 22 or other covering may alternatively or additionally cover the rigid buttons in a thin layer (so as not to overly dampen the pressure of the finger against the button actuator). In some instances, the first rigid material 23 and the second rigid material 21 may form an integral structure made of the same material. The integral structure may include a defined recess where at least a portion of the soft material 22 sits. The integral structure may sandwich the soft material 22 between outward extending portions to hold the soft material 22 in place.

It should be appreciated that cover structure 14 may comprise different, fewer, or additional materials than illustrated in FIG. 2. For instance, cover structure 14 may not include soft material 22 and/or may be formed of a single material, such as a plastic. As another example, a breathable material, which may be pleasant for a user to touch, such as lycra, leather (synthetic or real), cotton, velvet, nylon, or Jersey cloth, may be placed over the outer surfaces of foam 22. As another example, the cover structure may be configured with varying shapes and configurations, such as an inclined angle configuration, to satisfy different ergonomic considerations. Other variations are also contemplated.

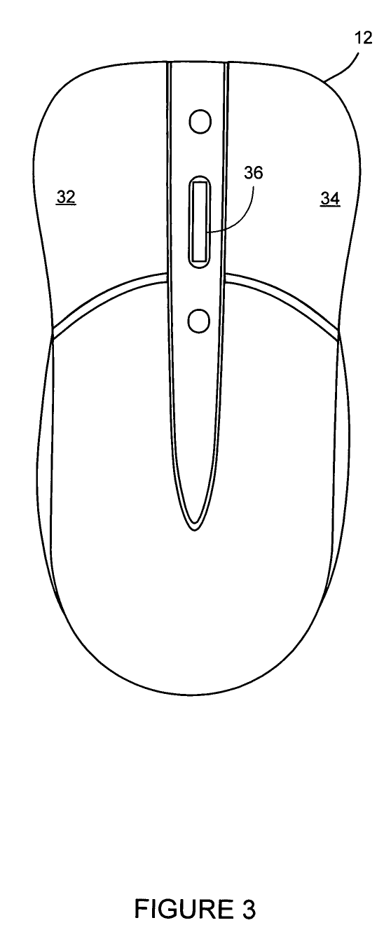

FIG. 3 illustrates an exemplary embodiment of a miniature input device 12. In this embodiment, miniature input device 12 is a mini-mouse. The mini-mouse may be an optical, mechanical, or other type of mouse. In some instances, the mini-mouse may be wireless. A wireless pointing device may use RF signals, infrared signals, etc. to communicate with a computer.

The mini-mouse may include optical, electrical, and/or mechanical components (not shown) well-known in the art to perform cursor control and selection. The mini-mouse also includes a plurality of buttons 32, 34. Left button 32 may be used to select a position for a cursor or to select graphical user interface objects, such as buttons, menu items, or hyperlinks. Right button 34 may be used for other types of interaction with a graphical user interface, such as the display of pop-up menus. Optionally, the mini-mouse may include a scroll wheel 36 to perform scrolling.

In alternative embodiments, miniature input device 12 may be a different type of device than illustrated in FIG. 3 (e.g., a trackball device). Additionally, in some embodiments, the miniature input device may be structured or include features to aid in the attachment of the miniature input device to a cover structure. By way of example, the miniature input device may include fastener mechanisms used to attach the miniature input device. Other changes may also be made to miniature input device so that it may be detachably coupled with a cover structure.

Referring to FIGS. 1 and 3, it is apparent that the buttons 32, 34 and the scroll wheel 36 can be accessed through an aperture in the cover structure 14. Advantageously, the miniature input device 12 can be easily converted to a computer input device 12 that is adapted for use with a normal adult size hand. Thus, contrary to conventional computer input devices, a consumer only needs to buy and use one computer input device, instead of buying and using both a miniature computer input device and a larger, standard input device. This saves the consumer money and reduces the number of computer input devices that need to be maintained by the user. This is particularly useful for business travelers who want to minimize the number and size of electrical devices to be carried.

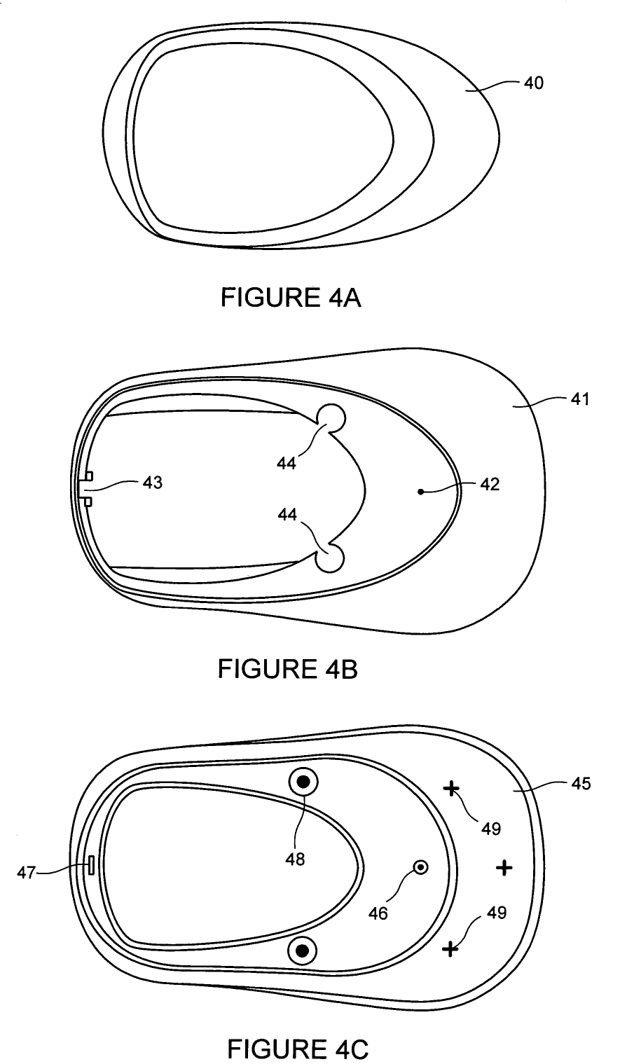

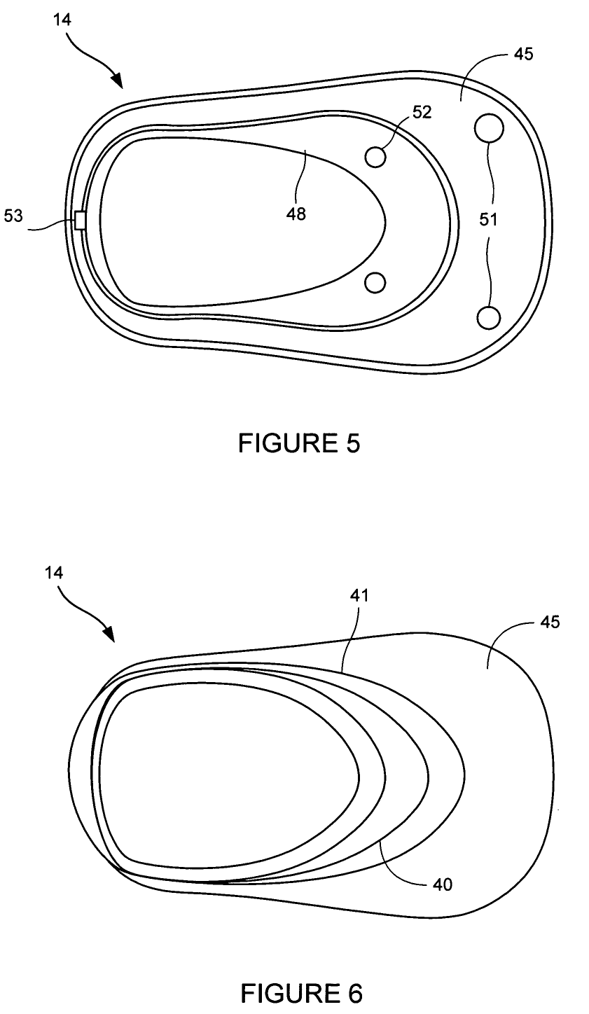

Referring to FIGS. 4-6 an exemplary assembly of a cover structure 14 will now be described. FIGS. 4A-4C show parts of the cover structure 14. FIG. 4A shows a top plan view of a bezeled structure comprising a rigid material. FIG. 4B shows a top plan view of a jacket. FIG. 4C shows a top plan view of a carrier. FIG. 5 shows a bottom plan view of the cover structure 14. FIG. 6 shows a top plan view of the cover structure.

Referring to FIGS. 4A-4C, cover structure 14 includes three components, bezeled structure 40, jacket 41, and carrier 45. Bezeled structure 40 may comprise a material, such as the rigid material 21 in FIG. 2 and may form a structure (e.g., a ring structure) through which one or more buttons 32, 34 of a miniature input device 12 may be accessed. A lower surface of bezeled structure 40 may include a projection (not shown) which may be inserted into a receiving cavity 42 of jacket 41.

Jacket 41 may comprise a soft material, which may be used to alleviate pressure of a user's hand during use of computer input device 10. By way of example, jacket 41 may comprise a self-skinning foam that forms a durable exterior layer (e.g., urethane), a non-self-skinning foam (which may be covered with a protective coating), a gel, or other suitable material. The top surface of the jacket 41 may form a recess, which may be used to receive a projection of bezeled structure 40. Jacket 41 may also have a hole 43 through which a snap or other mechanism of bezeled structure 40 may pass through to reach carrier 45. A plurality of additional holes 44 may be formed by jacket 41 and used to receive projections 48 formed by and protruding from a top surface of carrier 45.

Carrier 45 may comprise a rigid material and a material with a high coefficient of friction, such as an elastomer, thermoplastic rubber, or rubber on its inner surface to frictionally grip the miniature input device (not shown in FIGS. 4A-4C). Alternatively, carrier 45 may be formed of another material, such as a polycarbonate or other plastic. Carrier 45 includes a plurality of projections 49, which may be configured to fit into cavities formed by the underside of jacket 41. Additionally, carrier 45 includes a plurality of projections 48 that can be inserted into holes 44 of jacket 41 and a cavity 46 which may receive a projection (not shown) projecting from the bottom surface of bezeled structure 40. Carrier 45 also further includes a hole 47 which may be configured to mate with a snap on the underside of bezeled structure 40.

The cover structure 14 may be assembled by placing jacket 41 on top of carrier 45 so that the projections 48 are inserted through the holes 44 and projections 49 are mated with the corresponding cavities (not shown) formed in a lower surface of jacket 41. Bezeled structure 40 may then be placed on top, so that a projection (not shown) on the bottom surface of bezeled structure 40 is inserted through hole 42 into cavity 46.

With reference to FIG. 5 (which shows a view of the bottom surface of carrier 45 when assembled with jacket 41 and bezeled structure 40), screws 51 may be inserted through holes formed in a bottom surface of carrier 45 to secure the carrier to bezeled structure 40. Additionally, a snap 53 (formed by bezeled structure 40), may also be used to secure the parts of the cover structure 14 together. A low friction material 51, such as Teflon™ (or other fluoropolymer), may be used on parts of the bottom surface of carrier 45 to protect a work surface. The assembled cover structure 14 is illustrated in FIG. 6.

It should be appreciated that a wide number of variations may be made to the configurations of components 40, 41, and 45 to assemble the components together. For instance, instead of screws, a plurality of snaps or other to easily operated mechanism may be used to secure the assembly. As another example, a large number of variations may be made to the cavities, projections, and holes described above or other mechanisms may be used to removably couple bezeled structure 40, jacket 41, and carrier 45. It should also be appreciated that alternative embodiments may include additional or fewer components of a cover structure 13 (e.g., bezeled structure 40 may not be included).

The above-described method of construction and cover structure configuration provides a number of advantages. For example, because jacket 41 is removable from carrier 45 and is not permanently attached to the jacket 41, a user may easily be able to replace the jacket 41 with a new jacket. For instance, a manufacturer may make a number of different types of jackets, which may come in different colors and/or materials. A user may then choose a jacket 41 according to his or her personal preferences. Additionally, jacket 41 may easily be replaced in the event of wear and tear.

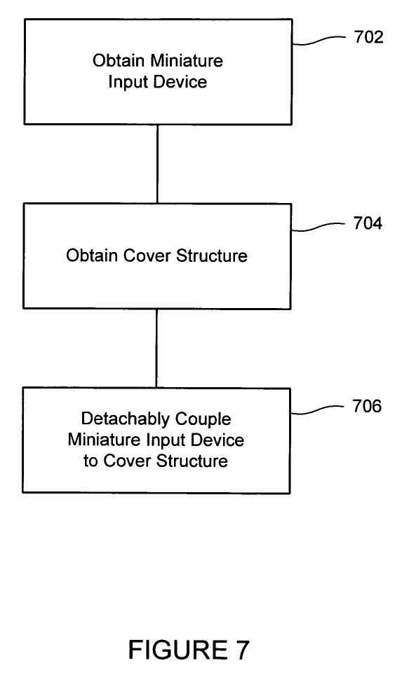

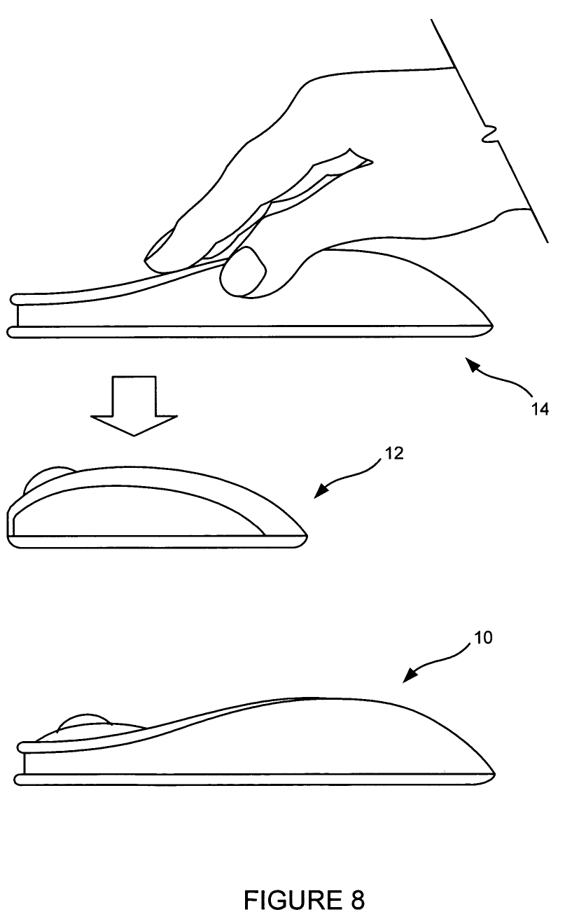

FIGS. 7 and 8 illustrate an exemplary method that may be used to assemble computer input device 10. The method may comprise obtaining 702 a miniature input device 12 (e.g., mini-mouse, mini-trackball) that has at least one button. A cover structure 14 is also obtained 704. Cover structure 14 is then detachably coupled 706 with the miniature input device 12 to form computer input device 10. By way of example, cover structure 14 may be detachably coupled by applying a downward force on cover 14 to couple cover structure 14 with miniature input device 10, which may cause cover 14 to “friction fit” to miniature input device 10. In alternative embodiments, fastener mechanisms, such as snap or loop and hook fasteners, or temporary bonding material may be used to detachably couple 706 miniature input device 10 with cover structure 14. Advantageously, no screws, no bolts, and no permanent adhesives are needed to removably couple the miniature input device and the cover structure 14 together. Moreover, the removable coupling can occur using a simple one step process where the user simply places the cover structure 14 on the miniature input device 10 in a single downward movement. Uncoupling can occur by simply pushing the miniature input device 10 out of the cover structure 14. This process is simple, intuitive and effective.

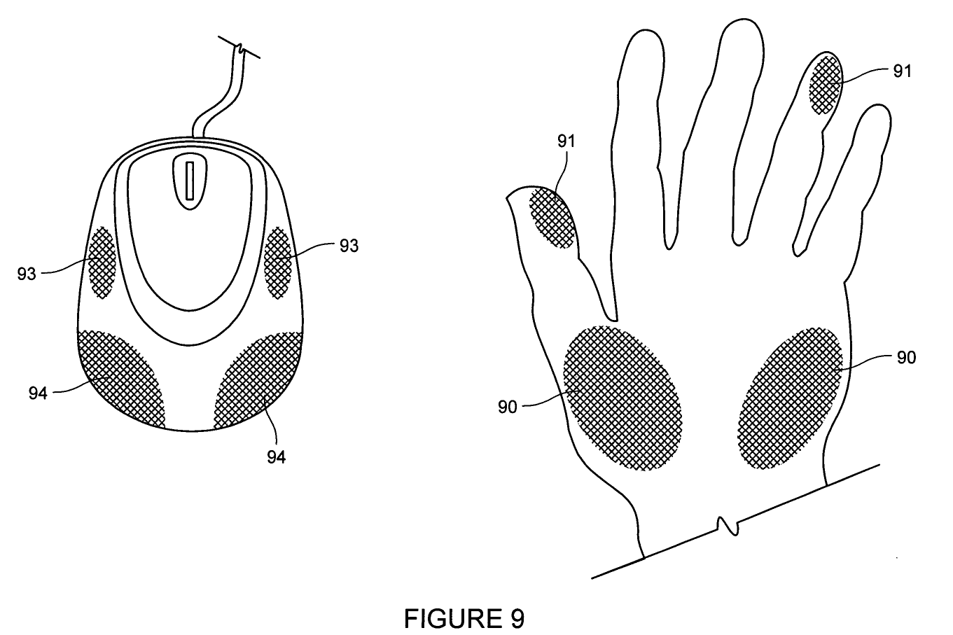

FIG. 9 illustrates general areas 90, 91 of a human hand that may be exposed to the highest compressive pressures during use of a mouse 92. Regions 91 designate areas of fingers that may be used to pick up mouse 92 by grabbing gripping regions 93 of mouse 92. The palm regions 90 of a user's hand may be subjected to a greater degree of compression by areas 94 during use of mouse 92. Similar pressure on a user's hand may also be caused by the use of a trackball.

According to one embodiment, in order to reduce pressure in regions 90, 91 caused by use of mouse 92, the palm regions 94 of mouse 92 may be formed of a soft material (described above), such as a foam, gel, elastomeric material, or other material. In some instances, the material may have a durometer value of less than 55 shore OO. The soft material may help reduce the pressure caused by use of the mouse 92. To further reduce pressure, regions 93 of mouse 92 may also be formed of a similar soft or cushioning material. In alternative embodiments, other types of computer input devices (e.g., trackball) may comprise soft material on the corresponding palm regions (and optionally gripping regions) of the device. Thus, in some embodiments, the soft material may extend around substantially all outer surfaces of the computer input device (except for the buttons, which and scroll wheel) which are typically rigid). This provides for a computer input device that allows a user to work comfortably. It is noted that this embodiment that uses a soft material in the vicinity of the user's palm may be incorporated into the embodiments 1-4 which use a miniature input device. However, the embodiment shown in FIG. 9 could be used with other computer input devices that do not use a miniature input device.

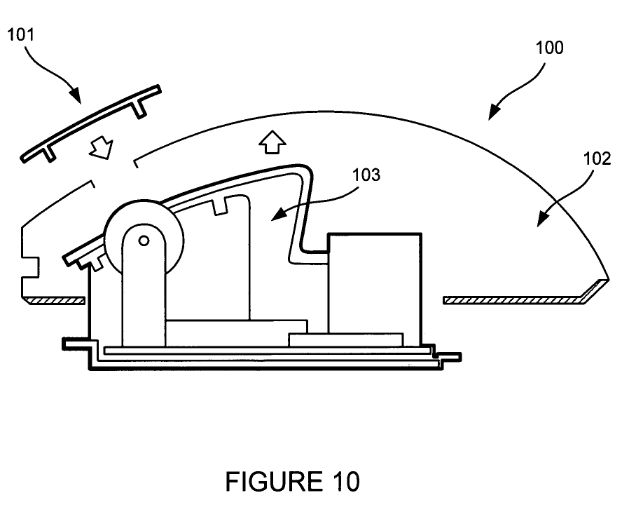

FIG. 10 illustrates another exemplary embodiment of a computer input device. Computer input device 100 may be a standard size or miniature input device, such as a mouse (mechanical, optical, etc.) or trackball. In some embodiments, computer input device 100 may use wireless communications to communicate with a computer.

Computer input device 100 may include a carrier 103. Carrier 103 may contain electrical and mechanical parts used during operation of computer input device 100. Carrier 103 may also include one or more buttons for actuation by a finger of the hand.

Computer input device 100 further comprises a jacket 102, which encircles carrier 103. Jacket 102 may comprise a soft or cushioning material, such as a foam, an elastomer material, or a gel material. The soft material may be used to reduce pressure in a palm region and/or gripping region of a user's hand caused by use of computer input device 100.

In some embodiments, jacket 102 may be detachably coupled with carrier 103. By way of example, carrier 103 may be inserted into a cavity defined by a lower surface of jacket 102. Other suitable mechanisms may also be used. Bezeled structure 101 may then be inserted to cleanly seal the opening formed by the cavity of jacket 102. In alternative embodiments, jacket 102 may be co-molded or otherwise permanently coupled with carrier 103.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A computer input device comprising:
a miniature input device including a button; and
a cover structure including a cavity for receiving the miniature input device and a gripping region for a hand, and
wherein the button is accessible through the cover structure.

2. The computer input device of claim 1, wherein the cavity is cooperatively structured with the miniature input device.

3. The computer input device of claim 1, wherein the cover structure includes a soft material.

4. The computer input device of claim 3, wherein the soft material comprises an elastomeric or foam material.

5. The computer input device of claim 1, wherein the cavity is formed by a ring structure that is formed in the cover structure.

6. The computer input device of claim 1, wherein the cover structure includes a palm region and a gripping region and wherein the soft material is in both the gripping region and the palm region of the cover structure.

7. The computer input device of claim 1, wherein surfaces defining the cavity comprise an elastomeric material.

8. The computer input device of claim 1, wherein the cover structure is configured to removably couple to the miniature input device by placing the cover on top of the miniature input device in one downward movement.

9. The computer input device of claim 8, wherein the miniature input device is at least partially held in place by friction forces applied by surfaces defining the cavity.

10. The computer input device of claim 1, wherein the cover structure comprises a carrier comprising a hard material, and a jacket comprising a soft material, wherein the jacket is removable from and encircles the carrier.

11. The computer input device of claim 1, wherein the miniature input device is a mouse.

12. The computer input device of claim 1, wherein the miniature input device comprises a trackball.

13. The computer input device of claim 1, wherein the cover structure is configured to modify dimensions of the miniature input device to a standard size input device.

14. A method comprising:
obtaining a miniature input device having a button;
obtaining a cover structure including a cavity for receiving the miniature input device and a gripping region for a hand;
placing the cover structure on the miniature input device; and
detachably coupling the cover structure to the miniature input device, wherein the button is accessible through the cover structure.

15. The method of claim 14, further comprising uncoupling the miniature input device from the cover structure.

16. The method of claim 14, wherein the cover structure is detachably coupled to the miniature input device by placing the cover on top of the miniature mouse in one downward movement.

17. A computer input device for controlling movement of a cursor on a computer display comprising:
a cover structure that includes a gripping region and a palm region for a hand, wherein the gripping region and the palm region include a soft material; and
a button for actuation by a finger of the hand.

18. The computer input device of claim 17, wherein the soft material comprises a material having a durometer value of less than about 70 shore OO.

19. The computer input device of claim 17, wherein the cover structure includes a cavity for receiving a miniature input device.

20. The computer input device of claim 17, wherein the cover structure comprises a carrier comprising a hard material, and a jacket comprising a soft material, and wherein the jacket is removable from and encircles the carrier.
